(19) United States
(12) Patent Application Publication
(10) Pub. No.: US 2006/0248247 A1
(43) Pub. Date: Nov. 2, 2006

(54) APPARATUS AND METHOD FOR CONTROLLING ACCESS TO A MEMORY

(75) Inventors: Malcolm Stewart, Ottawa, ON (CA); Denny Wong, Ottawa, ON (CA)

Correspondence Address: BLACKWELL SANDERS PEPER MARTIN LLP, 720 OLIVE STREET, SUITE 2400, ST. LOUIS, MO, 63101, US

(73) Assignee: Mtekvision Co., Ltd., Seoul (KR)

(21) Appl. No.: 11/380,558

(22) Filed: Apr. 27, 2006

Related U.S. Application Data
(60) Provisional application No. 60/675,899, filed on Apr. 29, 2005.

(51) Int. Cl. G06F 13/00

(52) U.S. Cl. 710/107

(57) ABSTRACT

An apparatus and method are provided for producing an assembly comprising a memory, a plurality of data buses and an interface for controlling access to the memory by each data bus. The interface is arranged to control memory access so that the plurality of devices can access different parts of the memory substantially simultaneously. A single interface is used to control memory accesses to different parts or elements of a memory substantially simultaneously so that a plurality of, or multiple memory accesses can be performed at the same time.

### CROSS REFERENCE TO RELATED APPLICATION

This application claims the benefit of U.S. provisional application Ser. No. 60/675,899, filed Apr. 29, 2005 the disclosure of which is incorporated herein by reference.

### BACKGROUND OF THE INVENTION

This invention broadly relates to a computer architecture particularly adapted for high bandwidth, high concurrency and multitasking operations. In a conventional computing system the central processing unit (CPU), main memory and input/output (I/O) devices are connected by a bus. A “bus master” or “bus arbiter” controls and directs data traffic among the components of the computing system. Main memory is used as the principal site for storing data. An “access” to main memory writes data to or reads data from main memory. Making an access (or “accessing”) is typically preceded by a request for access from another is component of the system, such as the CPU or an I/O device, followed by a grant of permission by the bus arbiter.

There are two principal types of accesses. The first type is a data access, in which large amounts of data are written to or read from main memory. A data access may be on the order of thousands of bytes. The second type is a control/status access, characterized by a small number of reads or writes to a defined data structure in order to report the status of an input/output device, process data, or initiate some input/output activity. In contrast to data accesses, a control/status access is usually on the order of a few bits. Control accesses are generally initiated by the CPU, while status accesses are generally initiated by the I/O devices.

Referring to FIG. 1, a typical application specific integrated circuit (“ASIC”) has one system bus 3 and one large memory block 5. Large memory blocks are normally preferred because they give better area efficiency. A single system bus can only access one memory location at a time.

In systems having more than one system bus, for example, as shown in FIG. 2A, the memory 5 is typically shared between the buses 3, 4. In the example of FIG. 2A, the memory is a dual-port memory with one set of memory I/Os connected to one bus and the other set of memory I/Os connected to the other bus. Typically, this type of memory configuration is used to move data from a device on one bus to a device on another bus. This configuration also allows the buses to operate at different speeds so that the memory interface acts as a buffer between clock boundaries. A dual ported memory typically requires twice the routing of a single port memory and is therefore twice the size. A dual port memory allows different data buses to access different row addresses at the same time but does not allow different data buses to access the same row address at the same time.

A dual port memory design allows access of a single memory from two busses. A typical dual port memory design is shown in U.S. Pat. No. 4,796,232. The '232 design provides access to a multiple bank, DRAM memory through two ports. A logic circuit arbitrates between read/write requests from the ports and DRAM refresh requests. The logic circuit allows one memory bank to be refreshed while another bank is accessed by a read or write to a port. The '232 design also uses a data register between each bus and the memory banks. A data register will accept, for example, a data element written from a bus thereby freeing that bus for other activity. However, subsequent data elements can not be written from that bus until the data element in the register is written into memory. The transfer of the data element from the register into memory may involve some delays because it must compete with transfer requests from the other bus and with refresh requests.

U.S. Pat. No. 4,656,614 to Suzuki discloses an apparatus usable to multiple simultaneous accesses to a memory. Suzuki describes an individual memory block made up of an array of memory bit cells. Suzuki describes a method for concurrently accessing two memory bit cells within the same memory block—this is well known today as a dual-port or a multi-port memory, as shown in FIGS. 4-8 of Suzuki '614. This invention is typically used in FIFO's (First In, First Out queues). However, a method for accessing an array of the memory blocks—not the memory bit cells is needed. Dual-ports as described by Suzuki have a sie penalty (2×). Suzuki does not disclose how to get access to different blocks of the memory array at the same time efficiently.

Another example of a system having more than one system bus is shown in FIG. 2B. In this example, the memory 5 is a single ported memory and is shared between the buses 3, 4. A memory interface (MIF) logic 7 is provided to arbitrate between the buses when they both make a memory request at the same time. As shown in FIG. 2C, to expand the memory in this system, a second memory block 8 is added in parallel to the first with its own memory interface logic 9. In a system in which it is desirable to use a large number of smaller memories, for example in a SIMD (single instruction multiple data) processor array, arranging each memory to access the system buses will reduce the maximum speed at which the system can operate, because of the capacitive loading of the MIF circuitry on the buses, and because of the capacitance associated with routing from each system bus to each MIF. Furthermore, the logic overhead required for an arbitration block for each memory would be excessively large. Accordingly, it would be desirable to provide an architecture and arrangement which provides efficient data transfer between different memories and different data buses of a multi-memory system.

### SUMMARY OF THE INVENTION

According to one aspect of the present invention, there is provided an apparatus comprising a memory, a plurality of devices and an interface for controlling access to the memory by each device, wherein the interface is arranged to control memory access so that the plurality of devices can access different parts of the memory substantially simultaneously.

In one embodiment, one or more devices comprise a bus, for example, a data bus or system bus. In this arrangement, a single interface is used to control memory accesses to different parts or elements of a memory substantially simultaneously so that a plurality of, or multiple memory accesses can be performed at the same time. Advantageously, providing a single interface to control memory accesses allows the circuitry required to implement this functionality to be significantly reduced in comparison to the example provided above, in which each memory element has its own system bus interface. The use of a single memory interface to control access to a plurality of memory elements by different data buses significantly reduces the capacitive loading on the data buses, allowing the buses to run at higher speeds. Furthermore, the interface is arranged to permit different data buses (or other devices) to access different parts of the memory or different memory elements at the same time, or in parallel. This significantly improves the efficiency of the system and increases the bandwidth of the memory in comparison to the above examples in which each memory interface allows only one system bus to access the memory at any one time. In addition, this arrangement allows the use of single port memories which are much smaller than dual port memories, and allows a plurality of single port memories to be accessed at the same time.

In some embodiments, the different parts of the memory or memory elements are arranged side by side in a row and/or in a column, and may be arranged in a 1-dimensional, 2-dimensional, or 3-dimensional array. Each memory part or element may comprise a discrete memory.

Each memory part or memory element may be a single ported-type memory, e.g. having a single row or column of I/Os, or may comprise a dual ported-type memory having two rows or columns of I/Os. Each memory part or memory element may comprise a contiguous array of data storage elements.

Embodiments of the invention may comprise three or more memory elements, a plurality of which can be selectively accessed independently at the same time. Thus, unlike a dual ported memory, which only allows two accesses at the same time, the present arrangement allows the memory to be more flexibly configured so that any number of buses or other devices can access the memory at the same time.

In some embodiments, the memory may be controlled by control signals which control all parts of the memory in the same way at the same time. In this case, the interface may permit different system buses to access different columns of memory at the same time. Data output from different columns or input to different columns may each have different row addresses, or the row addresses may be the same.

In other embodiments, operation of different parts or elements of the memory may be controlled independently of one another, so that, for example, one part of the memory can be placed in a data write mode and at the same time, another part of the memory can be placed in a data read mode. In this case, the different parts may comprise different memory elements.

In some embodiments, the memory comprises a plurality of memory elements, each memory element having a separate control for a read access and a write access, and the interface is adapted to enable a write access to at least one memory element by a data bus and a read access to at least one other memory element by another data bus substantially simultaneously or in parallel.

In some embodiments, the interface is responsive to requests by each data bus for a read access, to connect each data bus to a different memory element substantially simultaneously for a read access.

A respective read data bus may be connected between each memory element and the interface for carrying data from a respective memory element to the interface.

In some embodiments, a read data bus may be connected to a plurality of memory elements and to the interface for carrying data from the memory elements to the interface, and connected such that the read data bus is shared between the memory elements.

In some embodiments, the interface is responsive to requests by each data bus for a write access, to connect each data bus to a different memory element substantially simultaneously for a write access.

In some embodiments, a respective write data bus may be connected between each memory element and the interface for carrying data from the interface to a respective memory element.

In some embodiments, a write data bus may be connected to a plurality of memory elements and to the interface for carrying data from the interface to the memory elements, and connected such that the write data bus is shared between the memory elements.

In some embodiments, the interface is responsive to requests by each data bus for a read access, to connect each data bus to a different part or element of the memory substantially simultaneously for a read access.

In some embodiments, the memory has a single control for enabling read accesses thereto. For example, the interface may generate a common read control which is used to control a plurality of different memory elements.

In some embodiments, the memory comprises a plurality of columns of memory elements, each column having its own address bus and its own (internal or local) data bus, and the interface may be adapted to connect different columns of memory elements to different data buses substantially simultaneously or in parallel.

In some embodiments, the memory comprises a plurality of rows of memory elements, each row having its own address bus and its own (internal or local) data bus, and the interface may be adapted to connect different rows of memory elements to different data buses substantially simultaneously or in parallel.

The interface may be responsive to requests by each data bus for a write access, to connect each data bus to a different part or element of the memory substantially simultaneously for a write access.

In some embodiments, the memory has a single control for enabling write accesses thereto. For example, the interface may generate a common write control which is used to control a plurality of different memory elements.

In some embodiments, the memory comprises a plurality of columns of memory elements, each column having its own address bus and (internal or local) data bus, and the interface may be adapted to connect different columns of memory elements to different data buses substantially simultaneously or in parallel, to permit parallel write accesses.

In some embodiments, the memory comprises a plurality of rows of memory elements, each row having its own address bus and its own (internal or local) data bus, and the interface may be adapted to connect different rows of memory storage elements to different data buses substantially simultaneously.

In some embodiments, a plurality of processor elements may be coupled to the memory. In some embodiments, the memory may comprise a plurality of memory elements and one or more processor elements may be coupled to each memory element.

In some embodiments, the apparatus comprises a controller for controlling operations of the processor elements. For example, the controller may be adapted to control operations of each processor element substantially simultaneously. In some embodiments, the controller may be adapted to control each processor element to perform the same function substantially simultaneously.

According to another aspect of the present invention, there is provided an apparatus comprising a plurality of memories, an interface, a plurality of devices coupled to said interface, and wherein said interface is adapted to control access to said memories so that said plurality of devices can access different memories substantially simultaneously.

According to another aspect of the present invention, there is provided an apparatus comprising a plurality of memories, an interface, a plurality of devices coupled to said interface, and a plurality of address buses, wherein one address bus is couplable to at least one of said memories and another address bus is couplable to at least one other of said memories.

According to another aspect of the present invention, there is provided an interface for controlling access to a plurality of memories by one or more devices comprising means for receiving a memory access request from each device, means for detecting the identity of the memory to be accessed, and if two requests request access to different memories, the memory interface is adapted to permit access to said different memories, for example at different times or substantially simultaneously.

Further objectives and advantages of the present invention will become apparent from a careful reading of a detailed description provided hereinbelow, with appropriate reference to accompanying drawings.

### BRIEF DESCRIPTION OF THE DRAWINGS

Examples of embodiments of the present invention will now be described with reference to the drawings, in which:

FIG. 1 shows a block diagram of a first system;

FIG. 2A shows a schematic diagram of a second system;

FIG. 2B shows a schematic diagram of another system;

FIG. 2C shows a schematic diagram of another system;

FIG. 3 shows a block diagram of a system according to an embodiment of the present invention;

FIG. 4 shows a block diagram of a system according to another embodiment of the present invention;

FIG. 5 shows a schematic diagram of a data processor apparatus according to an embodiment of the present invention;

FIG. 6 shows an example of an implementation of the data processor apparatus of FIG. 5; and

FIG. 7 shows an example of a memory interface according to an embodiment of the present invention.

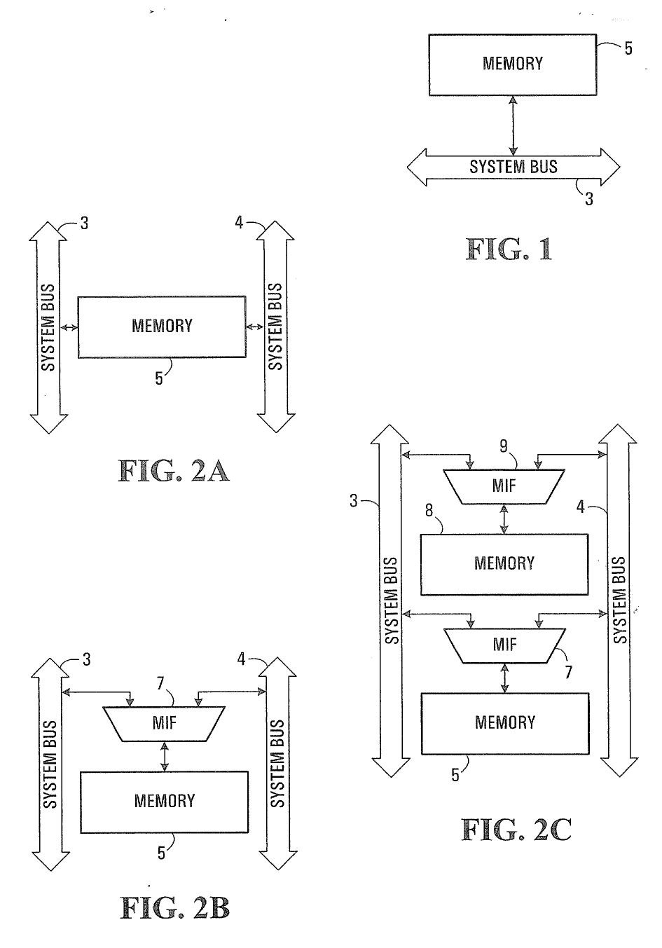

It should be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted. It should be understood, of course, that the invention is not necessarily limited to the particular embodiments illustrated herein. Like numbers utilized throughout the various Figures designate like or similar parts.

### DETAILED DESCRIPTION

In embodiments of the present invention, the apparatus comprises an interface which is able to service multiple buses at the same time as long as the buses do not operate on the memory in a manner that would be contrary to allowed memory operations. There are numerous ways in which the memory can be implemented to enable the interface to allow a plurality of data buses to operate thereon simultaneously, and non-limiting examples of various implementations are as follows.

(1) The memory may be implemented so that different parts of the memory are capable of operating in different modes at the same time. For example, the interface may be adapted to control one part of the memory for a read operation and another part of the memory for a write operation at the same time. Each part of the memory has an input and output data path and the input and output data paths (buses) may be shared between different parts of the memory or each part of the memory may have a separate input and output data path (bus). However, in this implementation in which the interface permits one read and one write access at the same time, a shared input path and a shared output path is sufficient. In this case, only two data buses are required (one read and one write) and therefore the routing is efficient. In some embodiments, in order to be able to perform two memory operations at the same time, so that one memory element performs one operation and another memory element performs another operation, two address buses may be provided from the memory interface to each memory element. A selector e.g. a 2:1 mux may be provided at the memory address input so that the appropriate address bus can be selectively connected thereto. This allows any two memory elements to be addressed at the same time so that both can perform a read, a write, or one can perform a read and another a write. The selectors may be controlled by the interface, and the WE signal may be used for this purpose.

(2) In another implementation, the interface may be adapted to permit a plurality of read accesses at the same time or a plurality of write accesses at the same time. For example, the memory may comprise a plurality of memory elements each controllable to be placed in read mode or write mode and each memory element may have its own input data bus and/or its own output data bus. In this case, the memory interface may be adapted to permit each system data bus to access an arbitrary address within each memory element in parallel. However, since each memory element has at least one dedicated data bus, the amount of required routing becomes large in large arrays.

(3) In another implementation, in which the memory elements are arranged in an array comprising a plurality of columns of memory elements, the memory interface may be adapted to allow concurrent access to different columns of memory element(s) at the same time. In this case, each column of memory elements would have its own data and address buses so that two or more different columns can be accessed at the same time.

(4) In another implementation, in which the memory elements are arranged in an array comprising a plurality of rows of memory elements, the memory interface may be adapted to permit concurrent access to different rows of memory elements at the same time. In this case, each row of memory elements would have its own data and address buses so that two or more different rows can be accessed at the same time.

(5) In another implementation, the memory interface may be adapted to allow concurrent access to different sub-arrays of memory elements at the same time. For example, in a two-dimensional array of memories, for example a 16×16 array of memories, the interface may be adapted to permit concurrent access to different sub-arrays within the array, for example different two-dimensional sub-arrays. The sub-arrays may be of any size, e.g. 2×2, 4×4, 2×4, 4×2, 8×4, 8×8, etc.

The memory elements within each sub-array may share at least one of the same data bus for write access, the same data bus for read access and the same address bus. The memory elements within the same sub-array may be controlled by at least one common control signal, for example a common memory enable signal which enables or disables all memory elements in the array, a write enable signal, which places all memory elements in the sub-array into write mode, a read enable signal which places all memory elements within the sub-array in read mode, and common high and low byte write enable signals. A sub-array of memory elements may either be completely independently controllable from other sub-arrays or different sub-arrays may share one or more data buses and/or one or more address buses and/or one or more control signals with one or more other sub-arrays.

For example, for completely independently controllable sub-arrays, each sub-array can be enabled or disabled independently of the others and can be independently write enabled or read enabled for access to any address within the array.

In a partially independently controllable sub-array, the sub-array may share the same read and/or write data bus with one or more other sub-arrays, in which case only one sub-array can read or write to the shared data bus at any one time. However, different sub-arrays having shared read and/or write data buses could be controlled by the memory interface so that data can be read from one sub-array and data written to the other, at the same time.

(6) In another implementation, the memory interface may be adapted to allow concurrent access to different sub arrays within a three-dimensional array of memory.

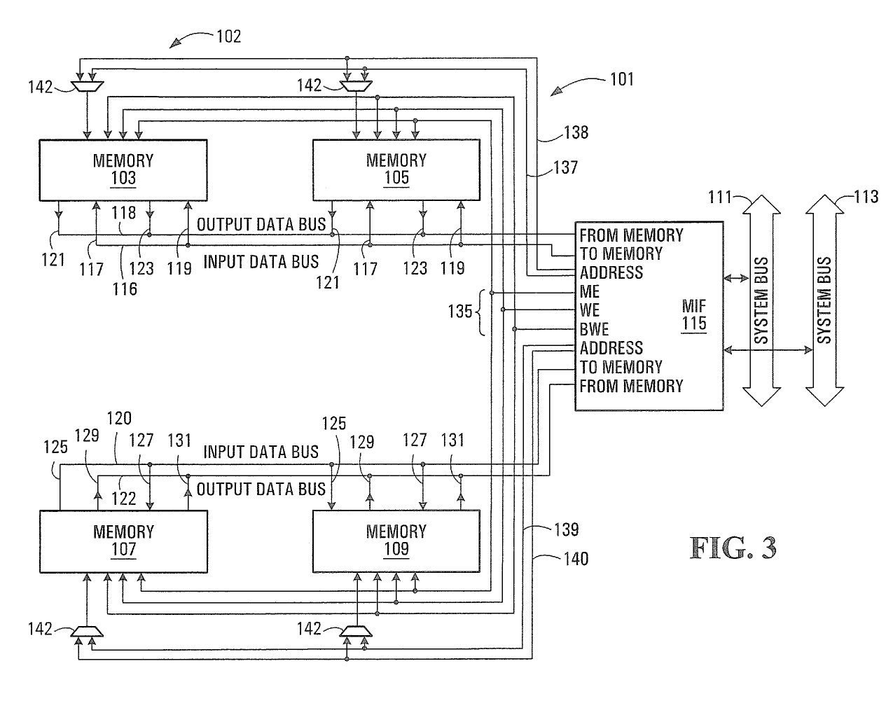

Referring to FIG. 3, an apparatus 101 according to an embodiment of the present invention comprises a memory 102 comprising a plurality of memory elements 103, 105, 107, 109, a plurality of data buses 111, 113, and a memory interface 115 for controlling access to the memory 102 by each data bus 111, 113. The memory interface is arranged to control memory access so that the data buses 111, 113 can access different parts of the memory 102 substantially simultaneously or in parallel.

In one embodiment, the system bus is used to carry both the memory address data and the data read from or written to memory (i.e. information data). In other words, the same one bit lines of the system bus are used to carry both address and information data and these are transmitted in different cycles or time frames in any order. Thus, for example, in a first cycle, the address and control data are sent to the memory interface and in a following cycle or cycles, the information data is sent. In another embodiment, the system bus may comprise separate dedicated control and data buses so that the information data and address data can be sent in parallel.

In this embodiment, the apparatus comprises a first input data bus 116 connected to the input ports 117, 119 of the first and second memory elements 103, 105 and which is connected to the memory interface 115, and a first output data bus 118 connected to the output ports 121, 123 of the first and second memory elements 103, 105 and to the memory interface 115. Thus, the first input data bus 116 is shared between the first and second memory elements 103, 105 for transferring data from the memory interface 115 to the first and second memory elements 103, 105. Similarly, the first output data bus 118 is shared between the first and second memory elements 103, 105 to transfer data from the first and second memory elements 103, 105 to the memory interface 115.

The apparatus further comprises a second input data bus 120 connected to the data inputs 125, 127 of the third and fourth memory elements 107, 109 and to the memory interface 115, and a second output data bus 122 connected to the data outputs 129, 131 of the third and fourth memory elements 107, 109 and to the memory interface 115. Therefore, in this embodiment, the second data input bus 120 is shared between the third and fourth memory elements 107, 109 to transfer data from the memory interface 115 to the third and fourth memory elements 107, 109. Similarly, the second output data bus 122 is shared between the third and fourth memory elements 107, 109 to transfer data from the memory elements 107, 109 to the memory interface 115.

The memory interface 115 includes a controller for generating control signals for controlling operations of the memory elements and a control bus 135 is connected between the memory interface 115 and each memory element 103, 105, 107, 109 for carrying the control signals. These signals may include a memory enable (ME) signal which controls turning on and off the memory, a write enable (WE) signal which controls the mode of operation of the memory between write mode and read mode, and optionally a byte write enable (BWE) signal which enables a subset of input/output ports of the memory to be selected, so that, for example, data words of variable length can be written into and output from the memory.

First and second sets of address buses 137, 138, 139, 140 are connected between the memory interface 115 and the first and second rows of memory elements, respectively, to control the row selector and possibly a column selector of each memory element. In this embodiment, each set comprises two address buses. A selector 142 (e.g. a 2:1 mux) is provided at the address input of each memory 103, 105, 107, 109 to selectively connect the appropriate address bus thereto. This allows any two memories to be accessed by one or more devices at the same time, for example for simultaneous writes, simultaneous reads or a write and a simultaneous read. It will be appreciated that any number of address buses selectively connectable to each memory element may be provided depending on how many devices are to be permitted to access the memory at the same time, or how many memory accesses are to be permitted at the same time, and the number of address buses may correspond to the number of such devices, or accesses, for example.

The interface may be adapted to generate an individual set of control signals for each memory element so that each memory element is independently controllable. For example, the memory interface may be adapted to generate separate memory enable signals for each memory element so that individual elements can be turned off when not in use to save power, for example. In another implementation, the memory interface may be adapted to generate one or more control signal(s) that are shared between a plurality of memory elements. For example, with reference to FIG. 3, the memory interface 115 may be adapted to generate one set of control signals which is common to both the first and second memory elements 103, 105, and a second independent set of control signals which is common to both the third and fourth memory elements 107, 109. In another implementation, the memory interface 115 may be adapted to generate a single set of control signals which are common to all memory elements.

Non-limiting examples of various operations of the memory system and memory interface are described below.

(1) Where the memory interface generates control signals which are common to all memory elements, the memory interface can place all memory elements simultaneously either in read mode or in write mode. In this case, the system buses 111, 113 can either both read data from the memory 102 or both write data to the memory. For example, the memory interface may permit the first system bus 111 to perform a memory read from the first memory group comprising memory elements 103, 105 or from the second memory group comprising memory elements 107, 109 and may simultaneously permit the second system bus 113 to perform a memory read from the other of the two memory groups, i.e. the group not being operated on by the first system bus 111.

Similarly, the memory interface may permit the first and second system buses to perform simultaneous memory write operations where one of the system buses 111, 113 performs a write operation on a memory element of one of the groups and the second system bus performs a write operation on a memory element of the other memory group.

(2) Where the memory interface is capable of generating separate control signals for each memory group so that each memory group can be controlled independently of the other, in addition to the above modes of operation, the memory interface can permit one system (or external) bus to perform a write operation on a memory element of one of the memory groups and at the same time permit another system (or external) bus to perform a memory read operation on a memory element of another memory group.

(3) Where the memory interface is adapted to generate control signals to independently control memory elements of the same group, the memory interface may permit, for example, one of the system buses 111, 113 to perform a write operation on one memory element of a predetermined memory group and at the same time permit another system bus to perform a read operation on another memory element of the same predetermined memory group. Thus, in one specific example, the memory interface 115 may be adapted to permit the first system bus 111 to perform a read access to the first memory element 103 and at the same time permit the second system bus 113 to perform a memory write operation to the second memory element 105, the first and second memory elements belonging to the same memory group.

Thus, the embodiment of FIG. 3 is configured to allow concurrent access to different memory elements, depending on the level of independency of control signals from the interface, with the exception of a concurrent read access to memory elements in the same row or a concurrent write access to memory elements in the same row (as the local data bus is shared). The permissible memory access operations that can be implemented in the embodiment of FIG. 3 with two system buses SB1 and SB2 can be summarized as follows:

Use Cases for Two System Buses

SB1 RD
SB1 WR
SB2 RD
SB2 WR
SB1 RD, SB2 WR (concurrent access is allowed on different memory elements only)
SB1 WR, SB2 RD (concurrent access is allowed on different memory elements only)
SB1 RD, SB2 RD (concurrent access is allowed on different memory ROWS only)
SB1 WR, SB2 WR (concurrent access is allowed on different memory ROWS only)
Idle

In a variation of the embodiment of FIG. 3, where memory elements in the same row share the same local data bus, but different local data buses are provided for different rows, and three system buses are connected to the interface, the pennissible memory access operations by the system buses SB1, SB2, SB3, can be summarized as follows:

USE Cases for 3 System Buses

SB1 RD
SB1 WR
SB2 RD
SB2 WR
SB3 RD
SB3 WR
SB1 RD SB2 WR (concurrent access is allowed on different memory elements only)
SB1 WR, SB2 RD (concurrent access is allowed on different memory elements only)
SB1 RD, SB2 WR, SB3 RD (concurrent access is allowed on different memory elements only, concurrent RDs on different rows)
SB1 RD, SB2 WR, SB3 WR (concurrent access is allowed on different memory elements only, concurrent RDs on different rows)
SB1 RD, SB2 RD (concurrent access is allowed on different memory ROWS only)
SB1 WR, SB2 WR (concurrent access is allowed on different memory ROWS only)
Etc . . . all other combinations as long as the buses are accessing different memory elements, and not doing two RDs or two WR in the same row.

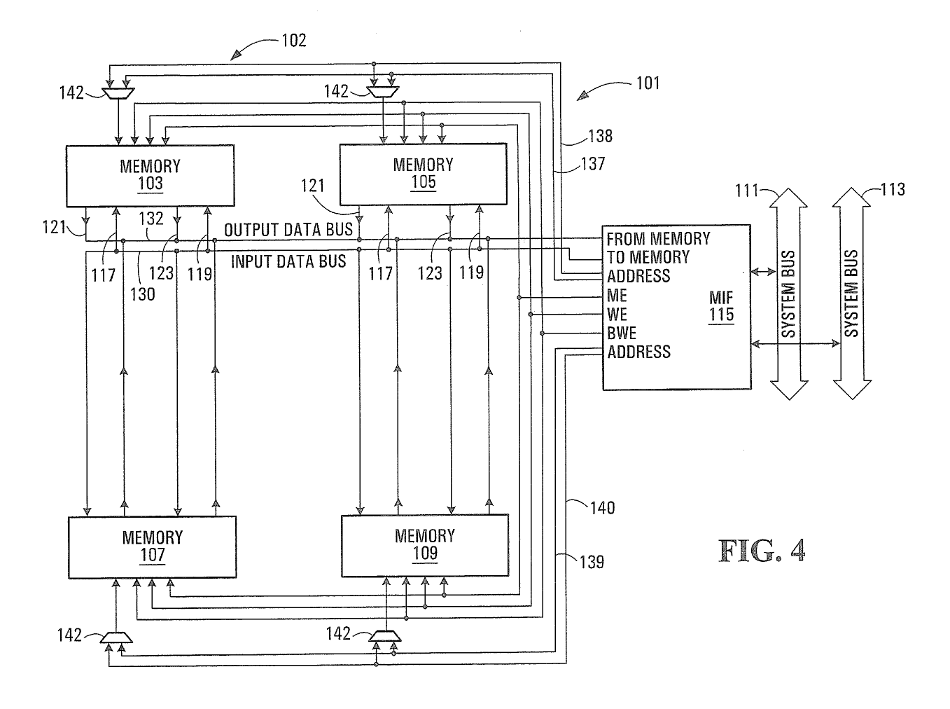

FIG. 4 shows an example of another embodiment of an apparatus or memory device or system according to another embodiment of the present invention. Referring to FIG. 4, the apparatus 101 is similar in some respects to the embodiment shown in FIG. 3, and like parts are designated by the same reference numerals. In particular, the apparatus 101 comprises a memory 102 having a plurality of memory elements 103, 105, 107, 109, a plurality of system buses 111, 113 and a memory interface 115 for controlling access to the memory by each data bus 111, 113. The main difference between this embodiment and that shown in FIG. 3 is that the data inputs of all memory elements 103, 105, 107, 109 are connected to the same input data bus 130 which is connected to the memory interface 115, and the data outputs of all memory elements 103, 105, 107, 109 are connected to a common data output bus 132.

In this implementation, since all memory elements share the same data input bus and all shares the same data output bus, for simultaneous operations, the memory interface is limited to permitting a read operation with a simultaneous write operation. For example, the memory interface may allow one of the system buses 111, 113 to perform a read operation on any one of the memory elements and at the same time permit the other system bus to perform a write operation on any other of the memory elements. In this case, the memory interface is adapted to generate control signals for independently controlling each memory element.

In a more limited implementation, the memory interface may be adapted to generate a common set of control signals for controlling operation of the memory elements of one memory group (e.g. memory elements 103, 105) and a second set of common control signals for controlling the memory elements of another memory group (e.g. the third and fourth memory elements 107, 109). In this case, the memory elements of the same group are all controlled in the same way so that all memory elements are either in read mode or write mode. In one example of this more limited implementation, the memory interface 115 is adapted to generate a common set of control signals for memory elements 103 and 105 and a second set of common control signals for memory elements 107, 109. In this case, the memory interface is limited to permitting a read access from either memory elements 103, 105 and a simultaneous write access to memory elements 107, 109, or a write access to memory elements 103, 105 and simultaneous read access to memory elements 107, 109.

In other embodiments, the memory interface may be adapted to generate control signals for independently controlling any one memory element or any group of memory elements comprising any number of memory elements, as desired or required.

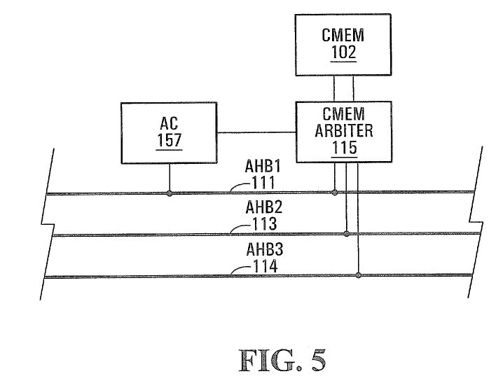

Embodiments of the present invention may be incorporated into a data processor apparatus, in which one or more processor units is coupled to each memory element of the memory. The processor units may be controlled by an array controller. The array controller may be adapted to control the processor units to perform operations in parallel to implement a SIMD (single data multiple instruction) processor. An example of such a system is shown in FIG. 5.

Referring to FIG. 5, the processor comprises a computational memory (CMEM) 102, which may comprise a plurality of memory elements each having one or more associated processor units, (not shown), a memory interface (or arbiter) 115, an array controller 157 and a plurality of system buses 111, 113, 114. Each system bus is connected to the memory interface 115, which controls access to the memory elements by each system bus and arbitrates between coincident accesses to the same memory element, as necessary. In this embodiment, the array controller 157 is also connected to the memory interface 115, and the interface also arbitrates between memory accesses by the processor units and system buses. The array controller is connected to at least one system bus 111 so that it can communicate with one or more other devices, such as an external processor (e.g. a RISC processor, an ARM processor or other processor). In some embodiments, the array controller 157 may also be adapted to request memory accesses, for example to broadcast data to one or more processor units via the memory elements, which advantageously eliminates the need for a dedicated broadcast bus between the array controller and processor units, as described in the applicant's co-pending U.S. provisional application filed on 29th Apr., 2005, attorney docket number 79135-24. In such embodiments, the memory interface may also be adapted to arbitrate between memory access by the array controller and memory accesses by other devices such as the system buses or processor units.

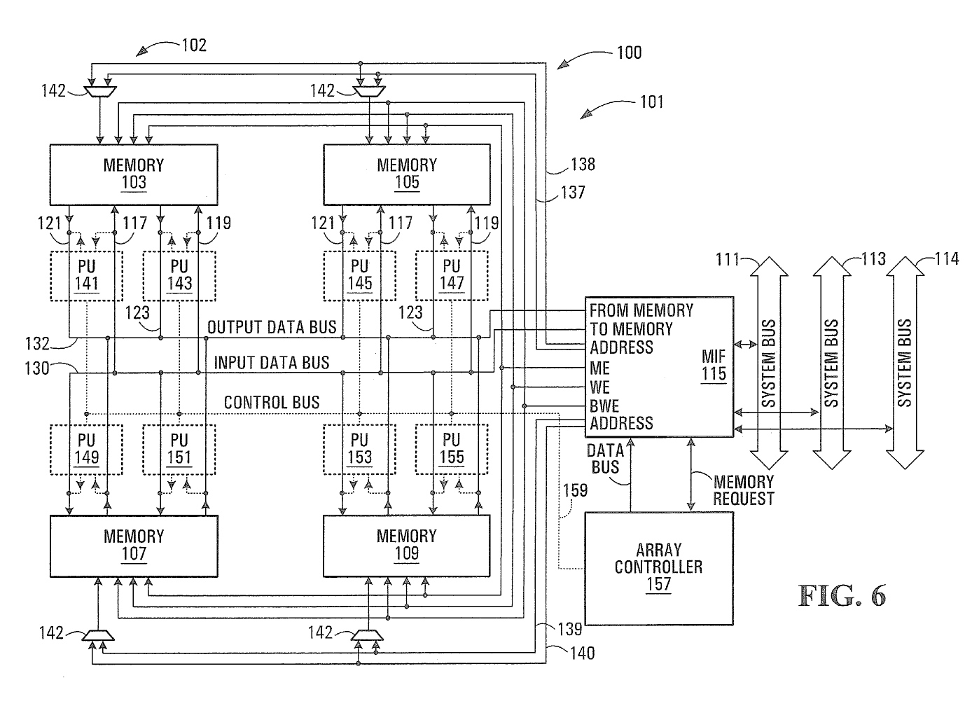

An example of an implementation of the data processor of FIG. 5 is shown in more detail in FIG. 6.

Referring to FIG. 6, a data processor 100 comprises a memory 102 which includes a plurality of memory elements 103, 105, 107, 109, a plurality of system buses 111, 113, 114 and a memory interface 115. These components are configured in a similar manner to the embodiment of FIG. 4, and like parts are designated by the same reference numerals. In addition, the data processor 100 comprises one or more processor units 141 to 155 associated with and coupled to each memory element. In this particular embodiment, each memory element has two processor units associated therewith. Thus, each processor unit effectively has its own local memory and can read data from the memory or write data to the memory. In one embodiment, each memory element is 16 bits wide and each processor unit is capable of processing data having a width of one byte. (However, in other embodiments, each memory element may have any width, e.g. 32, 64, 128, etc., and each PU may be capable of processing data of any desired width). The processor units may be reconfigurable so that processor units associated with the same memory element are capable of each processing separate data or capable of processing different bits of data within the same word. For example, the processor units may be configured to operate on 16 bit wide data with one processor unit operating on the high byte and the other operating on the low byte.

The data processor 100 includes an array controller 157 for controlling operations of the processor units 141 to 155, and a control bus 159 for carrying control signals from the array controller to each processor unit. The array controller 157 is also connected to the memory interface 115 and one or more buses may be provided between the array controller and memory interface to carry signals therebetween. In this example, a memory request bus 161 is provided for carrying memory request signals to the memory interface for requesting memory accesses by the processor units. An optional data bus 163 is also provided between the array controller and memory interface for carrying broadcast data from the array controller to the memory 102. Advantageously, the data bus 163 can be used to broadcast data to one or more processor units which removes the need for a dedicated broadcast bus between the array controller and each PU thereby saving routing and chip area, as described in the applicant's co-pending application (attorney docket number 79135-24) identified above.

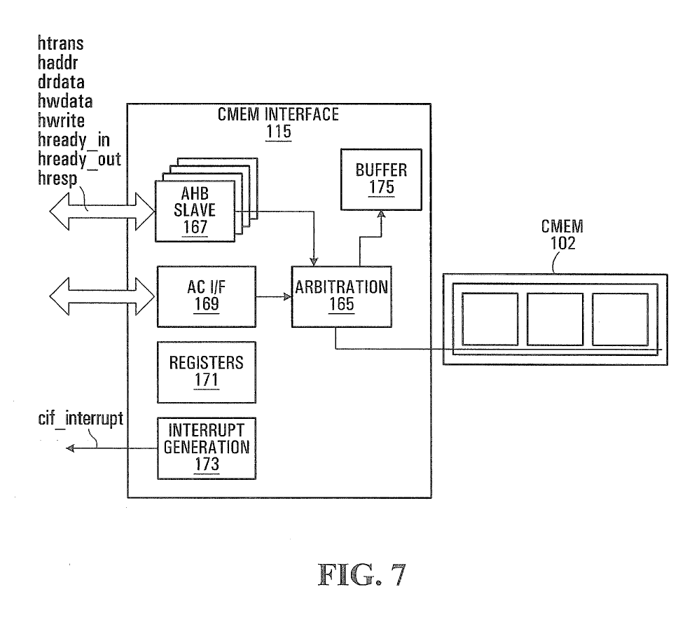

An example of a memory interface is shown in more detail in FIG. 7. Referring to FIG. 7, the memory interface 115 comprises an arbitrator or arbitration unit 165, a plurality of system bus slaves 167, an array controller interface 169, a plurality of registers 171 an interrupt generator 173 and a buffer 175. Each system bus slave 167 is connected to a respective system bus and acts as an interface between each system bus and the arbitration unit 165. Each system bus slave 167 detects memory access requests and passes the memory access request, together with the requested memory address to the arbitration unit 165. The array controller interface 169 receives memory requests from the array controller and passes the memory request and requested address information to the arbitration unit 165. The buffer 175 receives unfulfilled memory requests from the arbitration unit 165 and holds the requests in one or more queues. The buffer supplies unfulfilled memory requests to the arbitration unit 165 in response to requests from the arbitration unit, so that the memory request can be executed. Different devices may be given different priorities to access the memory, and this may be implemented by the arbitration unit 165 and/or the buffer 175. For example, the buffer may hold memory requests in different queues each having a different priority so that a high priority queue is emptied more frequently than a lower priority queue. The arbitration unit 165 generates control signals for accessing the memory 102 in accordance with each request.

The memory interface arbitrates access to the memory between all of the system buses attached to it. If the processor units are accessing the memory, generally, no other accesses are permitted because the processor units typically use all of the memory elements at the same time. If more devices try to access the memory than are allowed, the memory interface passes the data/address information through to the memory, while the inactive bus or buses wait for their turn. Control signals such as ME, WE and BWE are generated based on the type of access and the input address to the arbiter. For example, if the operation is from the array controller and is a memory store intended for the processor units, i.e. the processor units are controlled to write their data to the memory elements, all of the ME/WE signals will be set to 1. BWE signals may be generated by both the memory interface and by the individual processing elements and these signals may be logically combined (e.g. OR'd together) so that individual processing elements can independently control write operations to its local memory. Similarly, if the operation from the array controller is a memory read, the memory interface will generate ME=1 and WE=0.

If the operation is from an external bus, then the control signals (e.g. ME/WE/BWE) will be generated based on the address and type of access, e.g. read/write. In the example of FIG. 6, the following access cases are allowed: 1 read at a time, 1 write at a time and a concurrent read and write.

Assuming that the embodiment of FIG. 6 has two system buses, the permissible memory accesses and use cases may be summarized as follows:
CMEM only access RD/WR
SB1 RD
SB1 WR
SB2 RD
SB2 WR
SB1 RD and SB2 WR (concurrent access is allowed on different memory elements only)
SB1 WR and SB2 RD (concurrent access is allowed on different memory element only)
Idle

The apparatus may comprise any number of system buses and the memory interface may be adapted to control the access of any number of buses to the memory.

The memory may comprise any number of memory elements and the memory elements may be arranged in any manner, for example, as a one-dimensional array, a two-dimensional array or a three-dimensional array.

Each memory element may have any bit width and number of I/Os, for example 2, 4, 8, 16, 32, 64, 128, 256, 1024, or larger.

Where the interface is adapted to permit simultaneous access to the same memory element by different external data buses, different data buses may be permitted access to different memory I/Os in the same row (e.g. all positioned along either the upper edge of the memory, or all positioned along the lower edge of the memory); or in the same column (e.g. all positioned along one side of the memory).

Any aspect, embodiment or feature disclosed or claimed herein may be combined with any aspect, embodiment or feature disclosed in the applicant's co-pending application filed on 29th Apr., 2005, entitled “Data Processor Apparatus and Memory Interface”, attorney docket number 79135-24, the entire contents of which is incorporated herein by reference.

Other aspects or embodiments of the invention comprise any one or more feature disclosed herein in combination with any one or more other feature disclosed herein.

Numerous modifications and changes to the embodiments described above will be apparent to those skilled in the art.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An apparatus comprising:
a memory including a plurality of memory elements, each memory element having a control for a read access and a control for a write access;
a plurality of buses; and
an interface for controlling access to the memory by each bus,
wherein said interface is adapted to enable a write access to at least one memory element by a bus and a read access to at least one memory element by another bus substantially simultaneously so that plurality of data buses can access different parts of said memory substantially simultaneously.

2. An apparatus as claimed in claim 1, wherein said interface is responsive to requests by each bus for a read access, to connect each data bus to a different memory element substantially simultaneously for a read access.

3. An apparatus as claimed in claim 2, comprising a respective read data bus connected between each memory element and said interface for carrying data from a respective memory element to the interface.

4. An apparatus as claimed in claim 2, further comprising a read data bus connected to a plurality of memory elements and to the interface for carrying data from the memory elements to the interface and connected such that the read data bus is shared between said memory elements.

5. An apparatus as claimed in claim 1, wherein said interface is responsive to requests by each data bus for a write access, to connect each data bus to a different memory element substantially simultaneously for a write access.

6. An apparatus as claimed in claim 5, further comprising a respective write data bus connected between each memory element and said interface for carrying data from the interface to a respective memory element.

7. An apparatus as claimed in claim 5, further comprising a write data bus connected to a plurality of memory elements and to the interface for carrying data from the memory elements to the interface and connected such that the write data bus is shared between said memory elements.

8. An apparatus as claimed in claim 1, further comprising one or more processor elements coupled to each memory element.

9. An apparatus as claimed in claim 8, further comprising a controller for controlling operations of said processor elements.

10. An apparatus as claimed in claim 9, wherein said controller is adapted to control operations of each processor element substantially simultaneously.

11. An apparatus as claimed in claim 9, wherein said controller is adapted to control each processor element to perform the same function substantially simultaneously.

12. An apparatus as claimed in claim 1, wherein each memory element comprises a single port memory.

13. An apparatus as claimed in claim 1, wherein each part of said memory comprises a plurality of memory locations, and the parts are independently controllable such that any memory location in one part can be accessed at the same time as any memory location in another part.

14. An apparatus as claimed in claim 1, wherein each part of said memory can be independently turned on and off.

15. An apparatus as claimed in claim 1, comprising a plurality of address buses, each address bus being connectable to at least one memory part or element.

16. An apparatus as claimed in claim 15, further comprising a selector switch for selectively connecting one of said address buses to said at least one memory part or element.

17. An apparatus as claimed in claim 16, wherein said selector switch is responsive to a control signal from said memory interface, for example a write enable control signal.

18. An apparatus comprising:
a memory;
a plurality of buses; and
an interface for controlling access to the memory by each bus,
wherein said interface is responsive to requests by each bus for a read access to connect each data bus to a different part of said memory substantially simultaneously for a read access.

19. An apparatus as claimed in claim 18, wherein said memory has a single control for enabling read accesses thereto.

20. An apparatus as claimed in claim 18, wherein said memory comprises a plurality of columns of memory elements, and said interface is adapted to connect a memory element in each of a plurality of different columns of said memory to different data buses substantially simultaneously.

21. An apparatus as claimed in any one of claims 19, wherein said memory comprises a plurality of rows of memory elements and said interface is adapted to connect a memory element in each of a plurality of different rows of said memory to different data buses substantially simultaneously.

22. An apparatus comprising:
a memory including a plurality of memory elements;
a plurality of buses; and
an interface for controlling access to the memory by each bus,
wherein said interface is adapted to permit a bus access to at least one memory element of a first group of memory elements, and at the same time permit another bus access to at least one memory element of a second group of memory elements.

23. An apparatus as claimed in claim 22, wherein at least one of said first group of memory elements and said second group of memory elements share at least one resource.

24. An apparatus as claimed in claim 22, wherein said first group of memory elements have at least one resource that is separate and not shared by the second group of memory elements.

25. An apparatus as claimed in claim 23, wherein said resource comprises any one or more of a read data bus, a write data bus, an address bus, a memory enable control, a write enable control and a byte write enable control.

26. An apparatus as claimed in claim 22, wherein each memory element comprises a single port memory.

27. An apparatus as claimed in claim 22, wherein each part of said memory comprises a plurality of memory locations, and the parts are independently controllable such that any memory location in one part can be accessed at the same time as any memory location in another part.

28. An apparatus as claimed in claim 22, wherein each part of said memory can be independently turned on and off.

29. An apparatus as claimed in claim 22, comprising a plurality of address buses, each address bus being connectable to at least one memory part or element.

30. An apparatus as claimed in claim 29, further comprising a selector switch for selectively connecting one of said address buses to said at least one memory part or element.

31. An apparatus as claimed in claim 30, wherein said selector switch is responsive to a control signal from said memory interface.

32. An apparatus comprising:
a plurality of memories;
an interface;
a first data bus between said interface and at least one of said memories; and
a second data bus between said interface and at least one of said memories,
wherein said interface is adapted to control access to said memories so that said first and second data bus can access different memories substantially simultaneously.

33. An apparatus as claimed in claim 32, wherein said first data bus is connected to the input ports of said at least one memory and said second data bus is connected to the data output ports of at least one of said memories.

34. An apparatus as claimed in claim 32, wherein said first data bus is connected to the data input ports of at least one of said memories and the second data bus is connected to the input ports of at least one other of said memories.

35. An apparatus as claimed in claim 32, wherein said first data bus is connected to the data output ports of at least one of said memories and the second data bus is connected to the data output ports of at least one other of said memories.

36. An apparatus as claimed in claim 32, further comprising a plurality of address buses each being connectable to at least one of said memories.

37. An apparatus as claimed in claim 36, further comprising a selector for selectively connecting one of said address buses to at least one of said memories.

38. An apparatus comprising:
a plurality of memories;
an interface;
a plurality of devices coupled to said interface; and
a plurality of address buses,
wherein one address bus is coupled to at least one of said memories and another address bus is coupled to at least one other of said memories.

39. An apparatus as claimed in claim 38, wherein said interface is capable of outputting an address on each address bus to allow each device to access a different memory substantially simultaneously.

40. An apparatus as claimed in claim 38, wherein at least two of said address buses are connected to the same memory.

41. An apparatus as claimed in claim 38, further comprising a plurality of data processor units, wherein at least one respective data processor unit is coupled to a respective memory.
